(19) United States
(12) Patent Application Publication
(10) Pub. No.: US 2009/0073723 A1
(43) Pub. Date: Mar. 19, 2009

(54) PRISM SHEET AND BACKLIGHT MODULE USING THE SAME

(75) Inventors: TUNG-MING HSU, Taipei Hsien (TW); SHAO-HAN CHANG, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/938,307

(22) Filed: Nov. 12, 2007

(30) Foreign Application Priority Data
Sep. 17, 2007 (CN) 200710201738.4

(51) Int. Cl. F21V 5/02; F21V 7/04

(52) U.S. Cl. 362/620; 362/339

(57) ABSTRACT

An exemplary prism sheet includes a transparent main body. The main body includes a first surface, a second surface opposite to the first surface, a plurality of micro-depressions formed in the first and second surfaces respectively. Each micro-depression has four sidewalls connected in turn. A transverse width of each sidewall of each micro-depression progressively decreases with increasing distance from its bottom surface that are coplanar with one of the first and second surfaces of the transparent main body. A backlight module using the present prism sheet is also provided.

### CROSS-REFERENCE TO RELATED APPLICATIONS

This application is related to a co-pending U.S. patent application, which is: application serial no. [to be advised], Attorney Docket No. US16493, and entitled “PRISM SHEET AND BACKLIGHT MODULE USING THE SAME”. In the co-pending application, the inventors are Tung-Ming Hsu and Shao-Han Chang. The co-pending application has the same assignee as the present application. The disclosure of the above identified application is incorporated herein by reference.

### BACKGROUND OF THE INVENTION

1. Field of the Invention

The present invention relates to prisms, and particularly, to a prism sheet used in a backlight module.

2. Discussion of the Related Art

In a liquid crystal display device (LCD device), liquid crystal is a substance that does not itself illuminate light. Instead, the liquid crystal relies on light received from a light source to display information. In the case of a typical liquid crystal display device, a backlight module powered by electricity supplies the needed light.

FIG. 7 depicts a typical direct type backlight module 100. The backlight module 100 includes a housing 11, a plurality of lamps 12 disposed above a base of the housing 11, and a light diffusion plate 13 and a prism sheet 10 stacked on top of the housing 11 in that order. Inner walls of the housing 11 are configured for reflecting light upwards. The light diffusion plate 13 includes a plurality of dispersion particles (not shown) therein. The dispersion particles are configured for scattering light, thus enhancing the uniformity of light exiting the light diffusion plate 13.

Referring to FIG. 8 together, the prism sheet 10 includes a base layer 101 and a prism layer 102 formed on the base layer 101. The prism layer 102 contains a plurality of parallel prism lenses 103 having a triangular cross section. The prism lenses 103 are configured for collimating light to a certain extent. Typically, a method of manufacturing the prism sheet 10 includes the following steps: first, a melted ultraviolet (UV)-cured transparent resin is coated on the base layer 101 to form V-shaped lenses, then the melted UV-cured transparent resin is solidified to form the prism lenses 103.

In use, unscattered light from the lamps 12 enters the light diffusion plate 13 and becomes scattered. The scattered light leaves the light diffusion plate 13 and enters the prism sheet 10. The scattered light then travels through the prism sheet 10 before being refracted out at the prism lenses 103 of the prism layer 102. Thus, the refracted light leaving the prism sheet 10 is concentrated at the prism layer 102 and increases the brightness (illumination) of the prism sheet 10. The refracted light then propagates into an LCD panel (not shown) disposed above the prism sheet 10.

When the light is scattered in the light diffusion plate 13, scattered light enters the prism sheet at different angles of incidence. Referring to FIG. 9, when scattered light enters the prism sheet 10 at different angles of incidence, the scattered light generally travels through the prism sheet 10 along three light paths. In the first light path (such as a₁, a₂) the light enters the prism sheet at small angles of incidence and refracts out of the prism lenses with the refracted path closer to the normal to the surface of the base layer. In the second light path (such as a₃, a₄) the light enters the prism sheet 10 at angles of incidence larger than the first light path and refracts out of the prism lenses 103 with the refracted path being closer to the normal to the surface of the prism lenses 103. Both the first light path and the second light path contribute to the brightness of the LED and the light utilization efficiency of the backlight module 100. However, in the case of the third light path (such as a₅, a₆), the light enters the prism sheets at angles greater than the second light path, such that when the refracted light in the third light path leaves the prism sheet 10 at the prism lenses 103 the refracted light impinges on the surface of adjacent prism lens 103 and reenters the prism sheet 10. Thus, light traveling along the third light path will eventually reenter the prism sheet 10 and may exit the prism sheet 10 on the same side the light entered. This third light path does not contribute to the light utilization efficiency of the backlight module 100. Further, the third light path may interfere with or inhibit other incident light resulting in decreasing brightness of the backlight module 100.

What is needed, therefore, is a new prism sheet and a backlight module using the prism sheet that can overcome the above-mentioned shortcomings.

### SUMMARY

In one aspect, a prism sheet according to a preferred embodiment includes a transparent main body. The main body includes a first surface, a second surface opposite to the first surface, a plurality of micro-depressions formed at the first and second surfaces respectively. Each micro-depression has four sidewalls connected in turn. A transverse width of each sidewall of each micro-depression progressively decreases with increasing distance from its bottom surface that are coplanar with one of the first and second surfaces of the transparent main body.

In another aspect, a backlight module according to a preferred embodiment includes a plurality of lamps, a light diffusion plate and a prism sheet. The light diffusion plate is disposed above the lamps and the prism sheet is stacked on the light diffusion plate. The prism sheet is same as described in a previous paragraph.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and backlight module. Moreover, in the drawings, like reference numerals designate corresponding parts throughout several views, and all the views are schematic.

FIG. 1 is a side, cross-sectional view of a backlight module using a prism sheet according to a first preferred embodiment of the present invention.

FIG. 2 is an isometric view of the prism sheet of FIG. 1.

FIG. 3 is a top plan view of the prism sheet of FIG. 2.

FIG. 4 is a top plan view of a prism sheet according to a second preferred embodiment of the present invention.

FIG. 5 is a top plan view of a prism sheet according to a third preferred embodiment of the present invention.

FIG. 6 is a top plan view of a prism sheet according to a fourth preferred embodiment of the present invention.

FIG. 7 is a side cross-sectional view of a conventional backlight module employing a typical prism sheet.

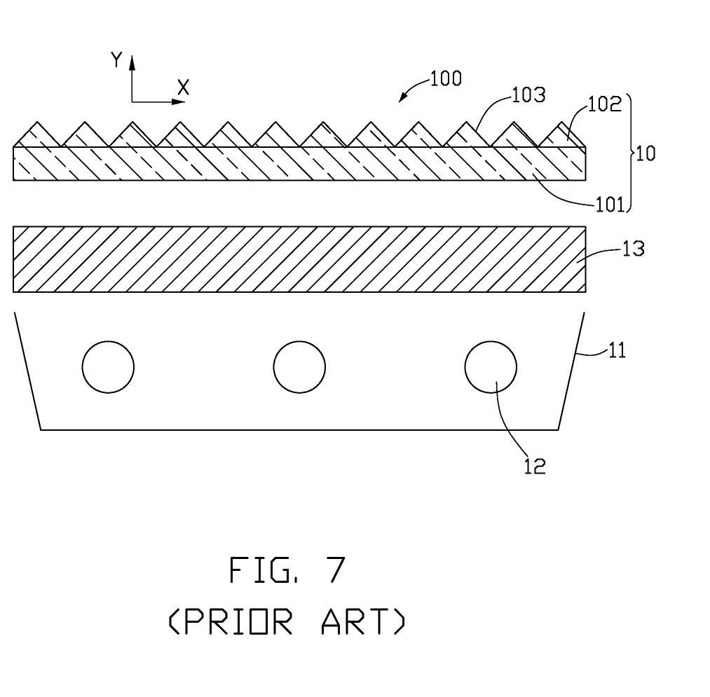

FIG. 8 is an isometric view of the prism sheet shown in FIG. 7.

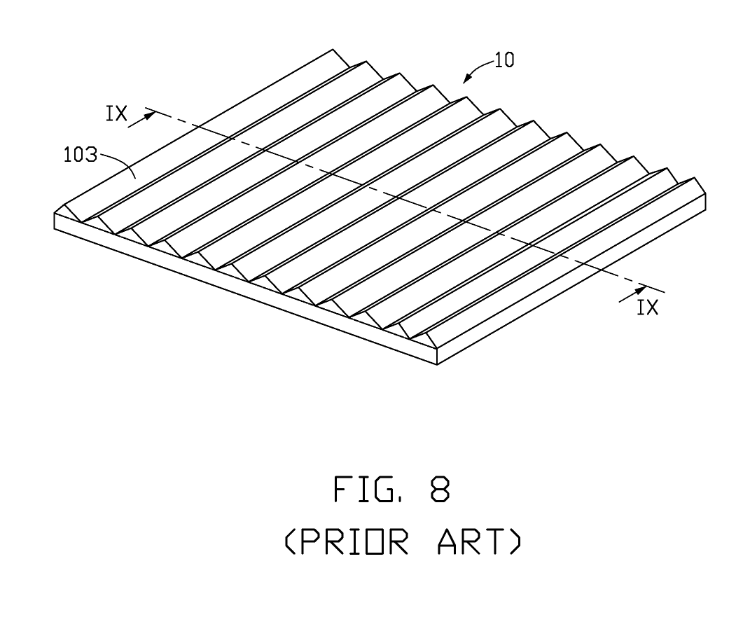

FIG. 9 is side, cross-sectional view of the prism sheet of FIG. 7, taken along line VIII-VIII, showing light transmission paths.

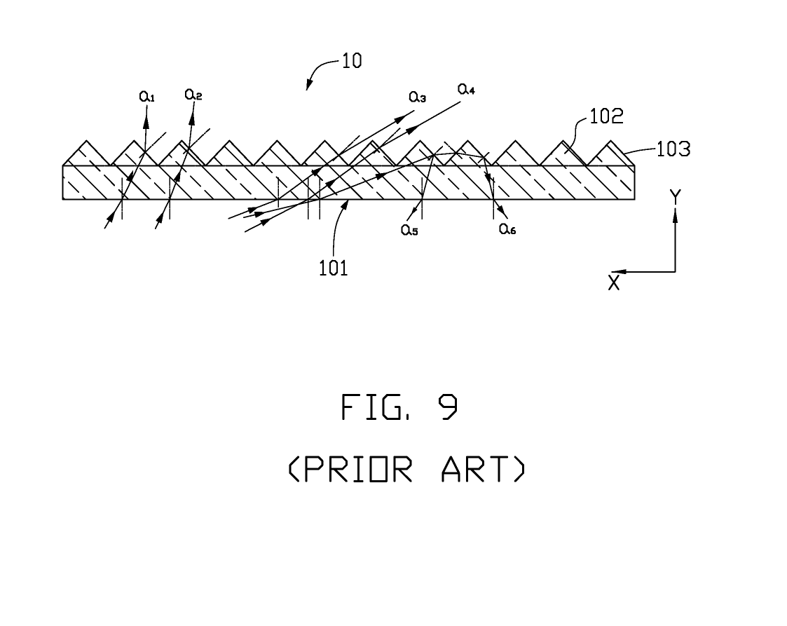

### DETAILED DESCRIPTION OF THE PREFERRED EMBODIMENTS

Reference will now be made to the drawings to describe preferred embodiments of the present prism sheet and backlight module, in detail.

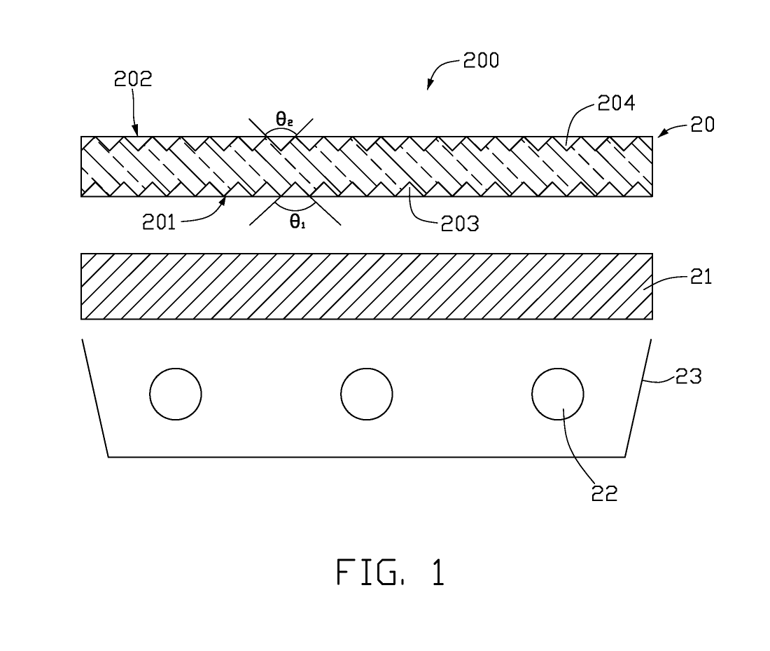

Referring to FIG. 1, a backlight module 200 in accordance with a first preferred embodiment of the present invention is shown. The backlight module 200 includes a prism sheet 20, a light diffusion plate 21, a plurality of lamps 22, and a housing 23. The lamps 22 are regularly aligned above a base of the housing 23. The light diffusion plate 21 and the prism sheet 20 are stacked on the top of the housing 23 in that order.

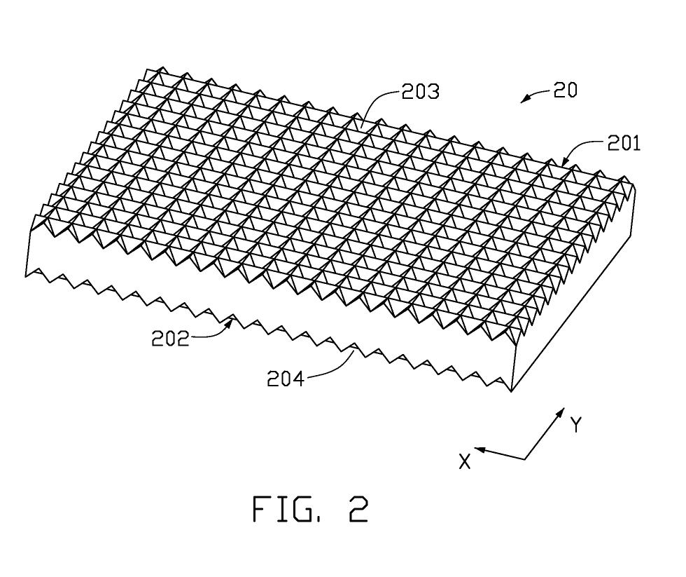

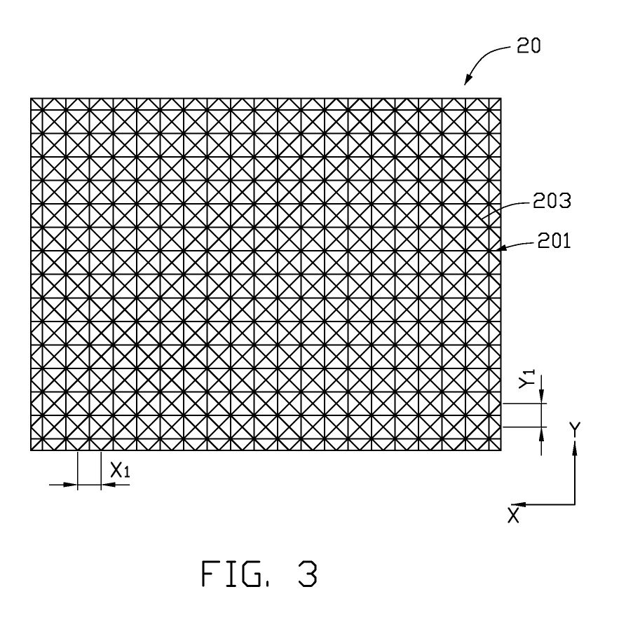

Referring to FIGS. 2 and 3, the prism sheet 20 includes a transparent main body. The main body includes a first surface 201, a second surface 202. Furthermore, the first surface 201 and the second surface 202 define a plurality of first micro-depressions 203 and a plurality of second micro-depressions 204 respectively. The first surface 201 and the second surface 202 are on opposite sides of the main body. The prism sheet 20 is stacked on the light diffusion plate 21 in a way such that the first surface 201 is adjacent to the light diffusion plate 23, and the second surface 202 faces away from the light diffusion plate 23. Each first micro-depression 203 (or second micro-depression 204) has a shape like an inverted prism and is enclosed by four triangular sidewalls connected with each other. In the first preferred embodiment, each first micro-depression 203 is a square pyramidal depression forming four triangular sidewalls. The triangular sidewalls are isosceles triangles. A transverse width of each of the triangular sidewalls progressively decreases with increasing distance from the first surface 201 (or the second surface 202).

In the first embodiment, the first micro-depressions 203 are formed in the first surface 201 according to a first matrix manner. The first micro-depressions 203 are configured for enabling the first surface 201 to converge incident light from the lamps 22 to a certain extent (hereafter first light convergence). Rows and columns of the first micro-depressions 203 in the matrix are parallel to the edges of the prism sheet 20 (along an X-axis and a Y-axis direction) correspondingly. A pitch between adjacent first micro-depressions 203 along the X-axis direction or the Y-axis direction is configured to be in the range from about 0.025 millimeters to about 1 millimeter. Again referring to FIG. 1, a dihedral angle θ₁, defined between sidewalls on opposite sides of each first micro-depression 203 is configured to be in the range from about 45 degrees to about 120 degrees.

In the first preferred embodiment, the second micro-depressions 204 are formed in the second surface 202 according to a second matrix manner according corresponding the first micro-depressions 203. The second micro-depressions 204 are configured for enabling the second surface to converge light emitting the second surface 202 (hereafter second light convergence). The second micro-depressions 204 are the same as the first micro-depressions 203. A pitch between adjacent second micro-depressions 204 along the X-axis direction or the Y-axis direction is also configured to be in the range from about 0.025 millimeters to about 1 millimeter. Again referring to FIG. 1, a dihedral angle θ₂, defined between sidewalls on opposite sides of each second micro-depression 204 is also configured to be in the range from about 45 degrees to about 120 degrees. In an alternative embodiment, the second micro-depressions 204 can be configured to be different from the first micro-depressions 203. Preferably, if the prism sheet 20 is stacked with the first surface 201 adjacent to the housing 23, the dihedral angle θ₂ of the triangular sidewalls in the second surface 202 is configured to be greater than the dihedral angle θ₁ of the triangular sidewalls in the first surface 201. In another alternative embodiment, rows or columns of the first micro-depressions 203 and the second micro-depressions 204 may be obliquely aligned to the sides of the prism sheet 20 correspondingly, thus having other alignments or orientations.

A thickness of the prism sheet 20 is preferably in the range from about 0.5 millimeters to about 3 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Referring to FIG. 1 again, the lamps 22 can be point light sources such as light emitting diodes, or linear light sources such as cold cathode fluorescent lamps. The housing 23 is made of metal or plastic materials with a high reflectivity rate. Alternatively, an interior of the housing 23 is preferably deposited with a high reflectivity coating for improving the light reflectivity rate of the housing 23. In this embodiment, the lamps 22 are cold cathode fluorescent lamps. The housing 23 is made of high reflective metal.

In the backlight module 200, when light enters the prism sheet 20 via the first surface 201, the light undergoes the first light convergence at the first surface 201. Then the light further undergoes a second light convergence at the second 202 before exiting the prism sheet 20. Thus, a brightness of the backlight module 200 is increased. In addition, due to the micro-depressions 203, the light exiting the prism sheet 20 would mostly propagate along directions close to the Y-direction. At the same time, less light would travel along directions close to the X-direction, minimizing the light energy loss. Thus, the light energy utilization rate of the backlight module 200 is high.

Furthermore, because the first and second surfaces 201, 202 form depressions having sidewalls expanding out of the prism sheet 20 at an angle, the light receiving area of the sheet is increased and the angles that the light refracts out (allowing the light to exit) of the prism sheet 20 is expanded. Additionally, the slope of the sidewalls of micro-depressions 203 and also the obliqueness relative to the edge of the prism sheet 20 can have various configurations according to predetermined viewing angles requirements of the backlight module 200. The prism sheet 20 can also be orientated to obtain appropriate viewing angle relative the latitudinal (X-direction) and longitudinal (Y-direction) directions of the backlight module 200. It could solve the problem that conventional prism sheets fail to satisfy most of the LCD displays' requirements on horizontal and vertical viewing angles.

Moreover, in contrast to the conventional prism sheet, the prism sheet 20 of the present invention is integrally formed by injection molding technology. Injection molding allows the prism sheet 20 to be easier to mass-produce than the conventional method. Furthermore, because the prism lenses of the conventional prism sheet are formed by solidifying the melted UV-cured transparent resin, the prism lenses of the conventional prism sheet are easily damaged and/or scratched due to poor rigidity and mechanical strength of the prism lenses. The prism sheet 20 of the present invention has better rigidity and mechanical strength than the conventional prism sheet. Therefore, the present prism sheet is not easily damaged or scratched.

It should be noted that, if the second micro-depressions 204 are configured to be different from the first micro-depressions 203, or the second micro-depressions 204 are intersected with the first micro-depression 203, or one of the first micro-depressions 203 or the second micro-depressions 204 are aligned obliquely with the LCD pixels either in the X-direction or the Y-direction. Accordingly, moiré pattern interference effect between the prism sheet 20 with the pixel pitch of LCD panel can be decreased or even eliminated.

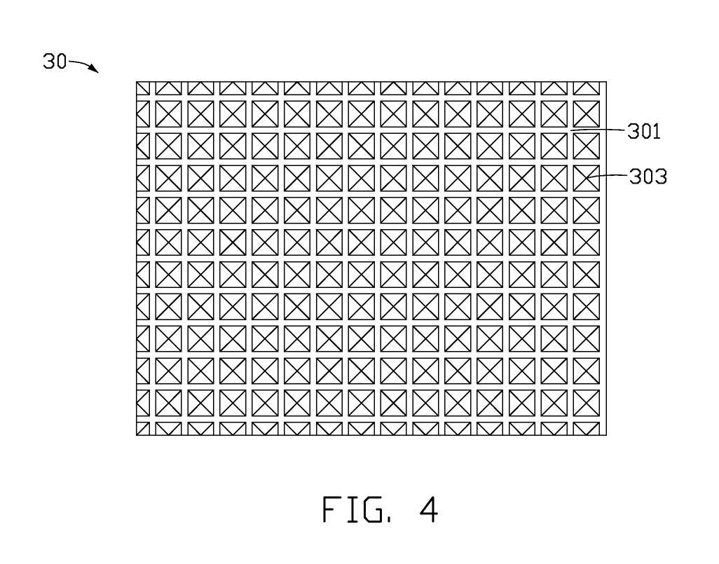

Referring to FIG. 4, a prism sheet 30 in accordance with a second preferred embodiment of the present invention is shown. The prism sheet 30 is similar in principle to the prism sheet 20. However, first micro-depressions 303 are aligned apart on first surface 301 of the prism sheet 30 in a matrix arrangement. Alternatively, second micro-depressions (not shown) can also be aligned apart in a matrix arrangement either according to the first micro-depressions 303 or being intersected with the first micro-depressions 303.

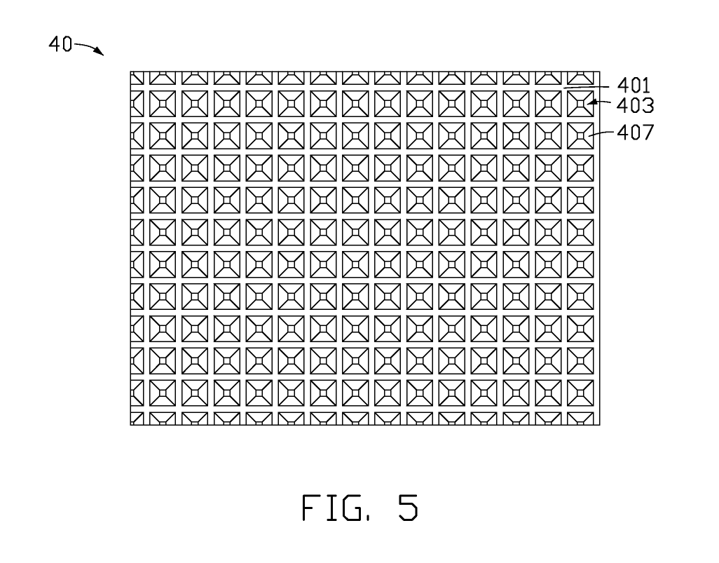

Referring to FIG. 5, a prism sheet 40 in accordance with a third preferred embodiment of the present invention is shown. The prism sheet 40 is similar in principle to the prism sheet 30, except that each of first micro-depressions 403 defined in first surface 401 is a frusto-pyramidal depression, and includes four inner connecting sidewalls 407. Each of the sidewalls 407 of the first micro-depressions 403 is an isosceles trapezium.

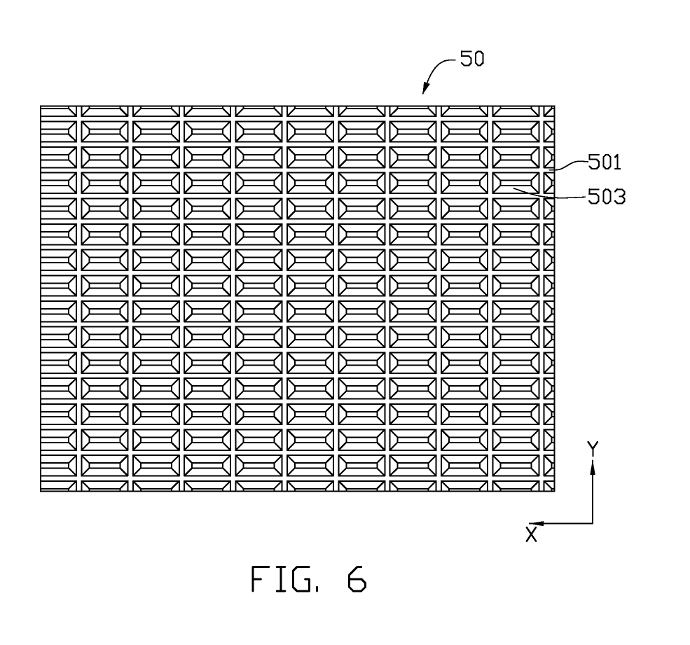

Referring to FIG. 6, an optical plate 50 according to a fourth embodiment is shown. The optical plate 50 is similar in principle to the optical plate 30, except that each of micro protrusions 503 of a first surface 501 is a polyhedron groove that includes four sidewalls. A first pair of opposite sidewalls of the four sidewalls is isosceles triangles with planar surfaces parallel to an X-axis. A second pair of opposite sidewalls of the four sidewalls is isosceles trapeziums with planar surfaces parallel to a Y-axis.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet comprising:
a transparent main body having:
a first surface,
a second surface opposite to the first surface,
a plurality of first micro-depressions formed in the first surface and a plurality of second micro-depressions formed in the second surface, wherein each of the first and second micro-depressions has four connecting sidewalls, wherein a transverse width of each sidewall progressively decreases with increasing distance from the sidewall bottom surface that are coplanar with one of the first and second surfaces of the transparent main body.

2. The prism sheet according to claim 1, wherein the first micro-depressions and the second micro-depressions are selected from a group consisting of rectangular pyramidal depression and frusto-pyramidal depression.

3. The prism sheet according to claim 1, wherein a dihedral angle defined between two opposite sidewalls of each of the first and second micro-depressions is configured to be in a range from about 60 degrees to about 120 degrees.

4. The prism sheet according to claim 1, wherein a pitch of the adjacent first and second micro-depressions is configured to be in a range from about 0.025 millimeters to about 1 millimeter.

5. The prism sheet according to claim 1, wherein a thickness of the prism sheet is in a range from about 0.5 millimeters to about 3 millimeters.

6. The prism sheet according to claim 1, wherein the first micro-depressions are distributed on the first surface in a matrix manner, and the second-depressions are distributed on the second surface according to the first micro-depressions.

7. The prism sheet according to claim 6, wherein rows or columns of the first micro-depressions and the second micro-depressions are parallel to or slanted to the respective edges of the prism sheet.

8. The prism sheet according to claim 1, wherein one of the first micro-depressions and the second micro-depressions are aligned apart on the first surface or the second surface.

9. The prism sheet according to claim 1, wherein one of the first micro-depressions and the second micro-depressions are aligned side by side on the first surface or the second surface.

10. The prism sheet according to claim 1, wherein the second-depressions are intersected with the second surface.

11. The prism sheet according to claim 1, wherein the prism sheet is made of transparent material selected from the group consisting of polycarbonate, polymethyl methacrylate, polystyrene, copolymer of methylmethacrylate and styrene, and any combination thereof.

12. A backlight module comprising:
a plurality of lamps;
a light diffusion plate disposed above the lamps; and
a prism sheet disposed on the light diffusion plate, the prism sheet includes a transparent main body having
a first surface,
a second surface opposite to the first surface, and
a plurality of first micro-depressions formed in the first surface and a plurality of second micro-depressions formed at the second surface, wherein each of the first and second micro-depressions has four sidewalls connected in turn, wherein a transverse width of each sidewall progressively decreases with increasing distance from its bottom surface that are coplanar with one of the first and second surfaces of the transparent main body.

13. The backlight module according to claim 12, wherein the first micro-depressions and the second micro-depressions are selected from a group consisting of rectangular pyramidal depression and frusto-pyramidal depression.

14. The backlight module according to claim 12, wherein a dihedral angle defined by two opposite sidewalls of each of the first and second micro-depressions is configured to be in a range from about 60 degrees to about 120 degrees.

15. The backlight module according to claim 12, wherein a thickness of the prism sheet is in a range from about 0.5 millimeters to about 3 millimeters.

16. The backlight module according to claim 12, wherein the first micro-depressions are distributed on the first surface in a matrix manner, and the second-depressions are distributed on the second surface according to the first micro-depressions.

17. The backlight module according to claim 16, wherein rows or columns of the first micro-depressions and the second micro-depressions are parallel to or slanted to the respective edges of the prism sheet.

18. The backlight module according to claim 12, wherein the second-depressions are intersected with the second surface.

19. The backlight module according to claim 12, wherein one of the first micro-depressions and the second micro-depressions are aligned apart on the first surface or the second surface.

20. The backlight module according to claim 12, wherein one of the first micro-depressions and the second micro-depressions are aligned side by side on the first surface or the second surface.
